(19) United States
(12) Patent Application Publication
(10) Pub. No.: US 2019/0339960 A1
(43) Pub. Date: Nov. 7, 2019

(54) System and Method to Deploy or Update Operating System Service Capabilities

(71) Applicant: DELL PRODUCTS, LP, Round Rock, TX (US)

(72) Inventors: Alexander Kucheravy, Cedar Park, TX (US); Nathan F. Martell, Taylor, TX (US); Srikanth Kondapi, Austin, TX (US)

(21) Appl. No.: 15/972,893

(22) Filed: May 7, 2018

(51) Int. Cl. G06F 8/65; G06F 21/57

(52) U.S. Cl. CPC G06F 8/65; G06F 2221/033; G06F 21/572

(57) ABSTRACT

An information handling system includes an application package and a service. The application package includes an assembly of at least one service function binary. The application is configured to send a register request to a service with a location of the assembly and send a service call for the service function binary to the service. The service receives the register request from the application, copies the assembly to a memory location, loads the service function, receives the service call from the application, and performs the requested service function and return the result to the application.

### FIELD OF THE DISCLOSURE

This disclosure generally relates to information handling systems, and more particularly relates to a system and method to deploy or update operating system service capabilities.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements can vary between different applications, information handling systems can also vary regarding what information is handled, how the information is handled, how much information is processed, stored, or communicated, and how quickly and efficiently the information can be processed, stored, or communicated. The variations in information handling systems allow for information handling systems to be general or configured for a specific user or specific use such as financial transaction processing, airline reservations, enterprise data storage, or global communications. In addition, information handling systems can include a variety of hardware and software components that can be configured to process, store, and communicate information and can include one or more computer systems, data storage systems, and networking systems.

### SUMMARY

An information handling system can include an application package having an assembly of at least one service function binary. The application can be configured to send a register request to a service with a location of the assembly and send a service call for the service function binary to the service. The service can be configured to receive the register request from the application, copy the assembly to a memory location, load the at least one service function, receive the service call from the application, and perform the requested service function and return the result to the application.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram of an information handling system according to one aspect of the disclosure;

FIGS. 2 and 3 are block diagrams of methods for deploying applications and services according to aspects of the disclosure;

FIG. 4 is a block diagram of a method for deploying service functions required by an application according to aspects of the disclosure; and

FIG. 5 is a sequence diagram illustrating deployment and execution of service functions required by an application in accordance to aspects of the disclosure.

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other teachings can certainly be utilized in this application. The teachings can also be utilized in other applications and with several different types of architectures such as distributed computing architectures, client/server architectures, or middleware server architectures and associated components.

An information handling system can include an application package having an assembly of at least one service function binary. The application can be configured to send a register request to a service with a location of the assembly and send a service call for the service function binary to the service. The service can be configured to receive the register request from the application, copy the assembly to a memory location, load the at least one service function, receive the service call from the application, and perform the requested service function and return the result to the application.

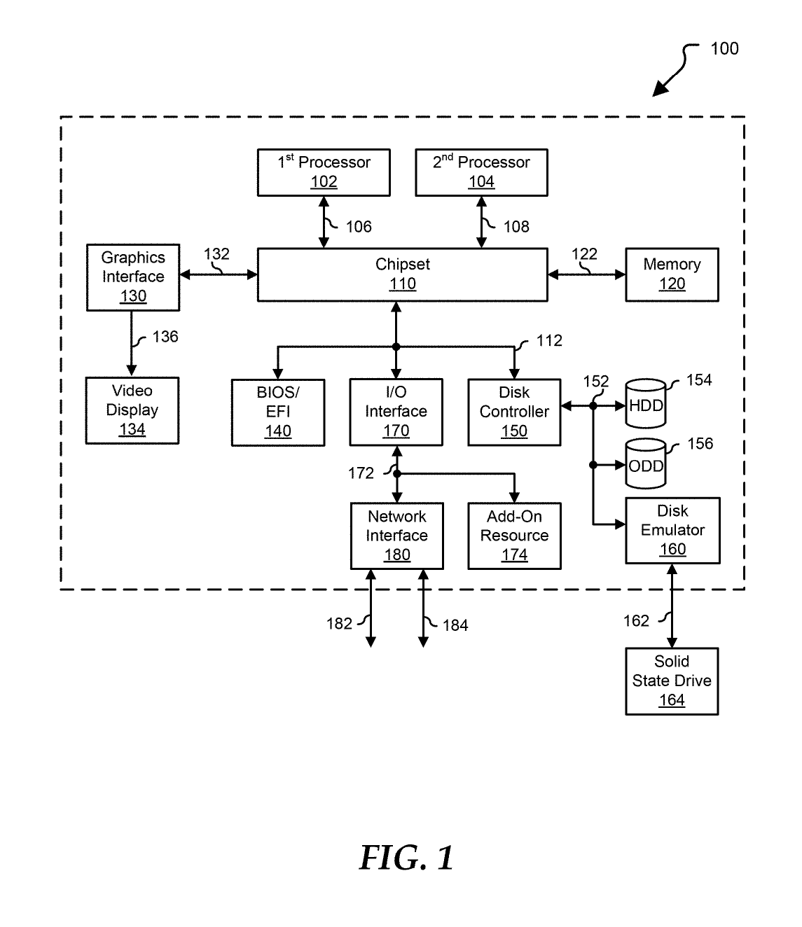

FIG. 1 illustrates a generalized embodiment of information handling system 100. For purpose of this disclosure information handling system 100 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 100 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 100 can include processing resources for executing machine-executable code, such as a central processing unit (CPU), a programmable logic array (PLA), an embedded device such as a System-on-a-Chip (SoC), or other control logic hardware. Information handling system 100 can also include one or more computer-readable medium for storing machine-executable code, such as software or data. Additional components of information handling system 100 can include one or more storage devices that can store machine-executable code, one or more communications ports for communicating with external devices, and various input and output (I/O) devices, such as a keyboard, a mouse, and a video display. Information handling system 100 can also include one or more buses operable to transmit information between the various hardware components.

Information handling system 100 can include devices or modules that embody one or more of the devices or modules described above, and operates to perform one or more of the methods described above. Information handling system 100 includes a processors 102 and 104, a chipset 110, a memory 120, a graphics interface 130, include a basic input and output system/extensible firmware interface (BIOS/EFI) module 140, a disk controller 150, a disk emulator 160, an input/output (I/O) interface 170, and a network interface 180. Processor 102 is connected to chipset 110 via processor interface 106, and processor 104 is connected to chipset 110 via processor interface 108. Memory 120 is connected to chipset 110 via a memory bus 122. Graphics interface 130 is connected to chipset 110 via a graphics interface 132, and provides a video display output 136 to a video display 134. In a particular embodiment, information handling system 100 includes separate memories that are dedicated to each of processors 102 and 104 via separate memory interfaces. An example of memory 120 includes random access memory (RAM) such as static RAM (SRAM), dynamic RAM (DRAM), non-volatile RAM (NV-RAM), or the like, read only memory (ROM), another type of memory, or a combination thereof.

BIOS/EFI module 140, disk controller 150, and I/O interface 170 are connected to chipset 110 via an I/O channel 112. An example of I/O channel 112 includes a Peripheral Component Interconnect (PCI) interface, a PCI-Extended (PCI-X) interface, a high-speed PCI-Express (PCIe) interface, another industry standard or proprietary communication interface, or a combination thereof. Chipset 110 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/EFI module 140 includes BIOS/EFI code operable to detect resources within information handling system 100, to provide drivers for the resources, initialize the resources, and access the resources. BIOS/EFI module 140 includes code that operates to detect resources within information handling system 100, to provide drivers for the resources, to initialize the resources, and to access the resources.

Disk controller 150 includes a disk interface 152 that connects the disc controller to a hard disk drive (HDD) 154, to an optical disk drive (ODD) 156, and to disk emulator 160. An example of disk interface 152 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 160 permits a solid-state drive 164 to be connected to information handling system 100 via an external interface 162. An example of external interface 162 includes a USB interface, an IEEE 1134 (Firewire) interface, a proprietary interface, or a combination thereof. Alternatively, solid-state drive 164 can be disposed within information handling system 100.

I/O interface 170 includes a peripheral interface 172 that connects the I/O interface to an add-on resource 174 and to network interface 180. Peripheral interface 172 can be the same type of interface as I/O channel 112, or can be a different type of interface. As such, I/O interface 170 extends the capacity of I/O channel 112 when peripheral interface 172 and the I/O channel are of the same type, and the I/O interface translates information from a format suitable to the I/O channel to a format suitable to the peripheral channel 172 when they are of a different type. Add-on resource 174 can include a data storage system, an additional graphics interface, a network interface card (NIC), a sound/video processing card, another add-on resource, or a combination thereof. Add-on resource 174 can be on a main circuit board, on separate circuit board or add-in card disposed within information handling system 100, a device that is external to the information handling system, or a combination thereof.

Network interface 180 represents a NIC disposed within information handling system 100, on a main circuit board of the information handling system, integrated onto another component such as chipset 110, in another suitable location, or a combination thereof. Network interface device 180 includes network channels 182 and 184 that provide interfaces to devices that are external to information handling system 100. In a particular embodiment, network channels 182 and 184 are of a different type than peripheral channel 172 and network interface 180 translates information from a format suitable to the peripheral channel to a format suitable to external devices. An example of network channels 182 and 184 includes InfiniBand channels, Fibre Channel channels, Gigabit Ethernet channels, proprietary channel architectures, or a combination thereof. Network channels 182 and 184 can be connected to external network resources (not illustrated). The network resource can include another information handling system, a data storage system, another network, a grid management system, another suitable resource, or a combination thereof.

The complexity of information handling systems can make them vulnerable to malicious activities. Network connected devices can be attacked remotely. Operating systems and software packages can include security flaws that leave them vulnerable to exploitation. Authorized users can be tricked into revealing access codes or running malicious software. Significant effort is expended in trying to secure systems from malicious activity, including training authorized users, identifying and patching security flaws in the software, and hardening network connections through the use of firewalls and the like. However, even with all these efforts, information handling systems continue to be exploited, due to lapses in user training, exploitation of unidentified or unpatched security flaws, and the like.

The execution of malicious code, either by user error or system compromise, continues to be a major source of security issues. For example, a user mistakenly executing ransomware can cause significant loss of data and business interruption when the ransomware encrypts critical data. Several techniques can be utilized to minimizing execution of malicious code. Antivirus software that scans code before it is allowed to execute can detect known threats but is often resource intensive and may not be able to identify novel threats. Notifying the user that code is of an unknown origin and requiring additional manual approvals can provide a reminder of the risks, but ultimately requires the user to make the correct decision. Additionally, with repeated manual approval, there is a tendency of users to just click through notifications.

Limiting activities that are outside of the normal operations can further reduce the risk of compromise. Code can be sandboxed to limit data access and/or access controls can be used to limit the actions that can be performed so that any malicious activity is limited in scope. In another example, the system may only allow execution of signed code that is known to be safe. For example, a system may only install software available through a curated online store where all the available software can be tested before it is made available. Additionally, the online store curator may impose limits on the available software, such as restricting what actions can be performed or which APIs can be used. Limiting users to software only available through a curated store and/or limiting the functions that can be performed by user installed code can cause issues with services that require interaction with hardware.

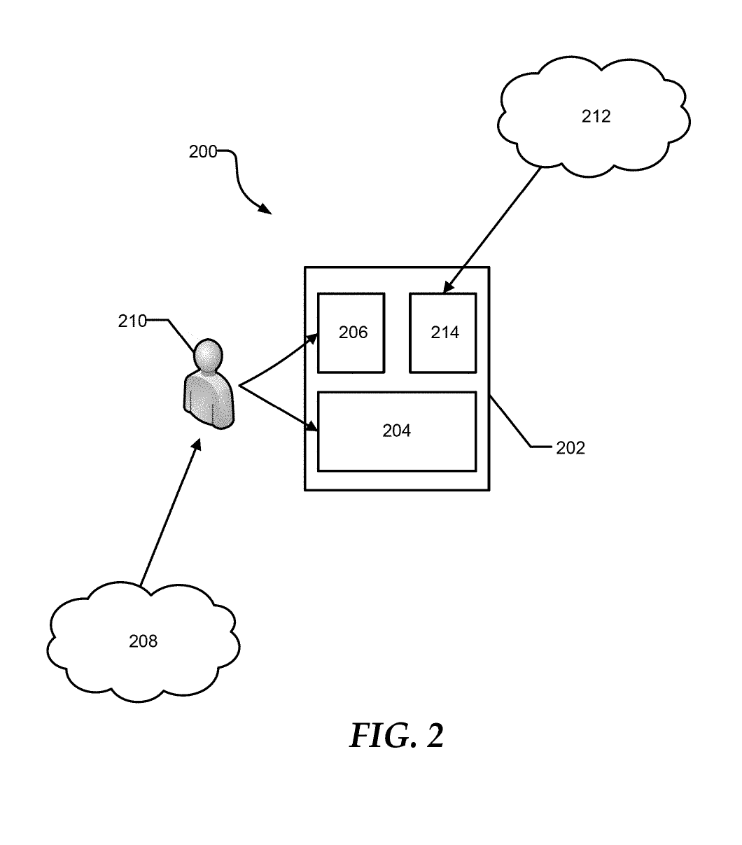

FIG. 2 illustrates mechanisms 200 of software deployment on a client system 202, such as information handling system 100. Traditionally, client system 202 can be shipped with software bundled by the Original Equipment Manufacturer (OEM). The bundled software can include legacy applications 204 and NT Services 206. In various embodiments, the legacy applications 204 and the NT Services 206 can work together to provide a customized experience for client system 202. For example, legacy applications 204 and NT services 206 can support configuration of power management features and other subsystems provided by the OEM. An OEM support site 208 can provide updates to bundled software and/or provide additionally legacy applications 204 and NT Services 206. For example, the OEM support site 208 can provide drivers and related applications for additional hardware that is installed or connected to client system 202 by a user 210. In some embodiments, user 210 may visit the OEM support site and download the latest updates. In some embodiments, an automatic update feature for the OEM software can be enabled, either automatically updating the software or by notifying the user when an update is available.

As another mechanism for software deployment, a curated application store 212 can be provided, such as by the operating system provider. Policies can limit what actions can be performed by applications available through the application store 212, and applications available can go through a screening process to ensure the policies are followed and that malicious code is not made available through the curated application store 212. Additionally, applications available through the application store 212 can be signed by the store provider to certify that the application is “safe”. Store Applications 214 can be downloaded by client system, the signature can be checked, and the software functions made available. Additionally, auto update mechanisms may be enabled so that Store Applications 214 can be periodically updated (with or without user intervention) to ensure the latest software is installed.

In some embodiments, the operating system provider may limit the type of software that can be available in the application store 212. For example, software may be limited to the user level privileges and the applications may be sandboxed or virtualized so that interaction with data from other software and interaction with the system hardware is limited. In other embodiments, the software may be limited to a subset of allowable APIs.

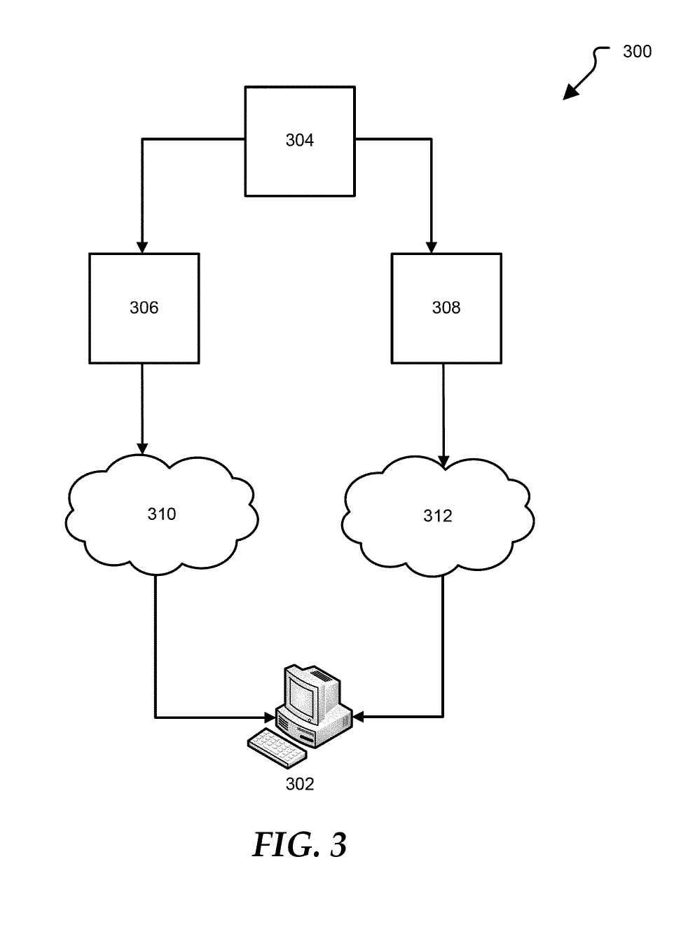

FIG. 3 is a block diagram illustrating a further mechanism 300 for installing software on a client system 302, such as information handling system 100. A hardware provider 304 can split the software into a user interface component 306 and a service component 308. The user interface component 306 can be compatible with the requirements of application store 310, and the service component 308 can be made available through a driver update service 312. Client system 302 can receive updates to the user interface component 306 through the application store 310 and updates to the service component through the driver update service 312.

In various embodiments, an application available through an application store can require a service component to be installed on the system for proper functioning. For example, the application can provide a user interface for configuring subsystems may not have the desired result if the service component is not available to make changes to the operation of the underlying hardware. However, ensuring compatible versions of both the application and the service component are installed can be problematic when splitting the service component and the application providing the user interface. For example, a user may go to the application store and obtain the user interface component and either not follow through or not be aware of the need to install the service component. In another example, the application may receive an update prior to the service component receiving the update. The out of date service component may cause the application to break or may prevent usage of new features of the application until the service component is updated.

One method to resolve the dependency issues can include providing a high-level service component and having the application carry a package containing code for the required service functions. The high-level service component can obtain the package from the application and can load the code for the service functions. Then the application can access the service functions through the high-level service component. In this way, the application can have access to compatible versions of the necessary service functions.

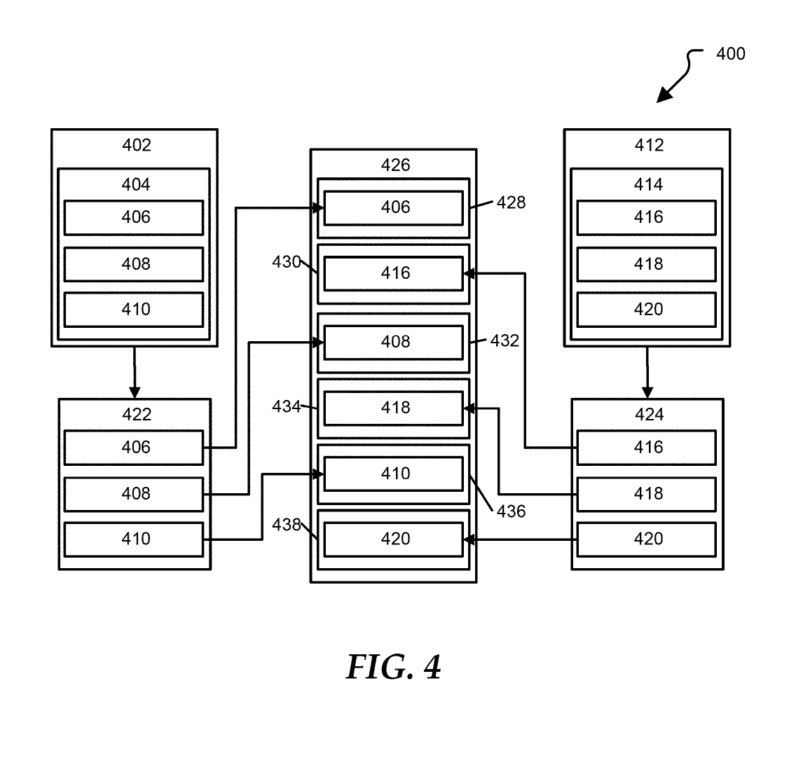

FIG. 4 is a block diagram illustrating a system for providing service functions to applications. Application 402 can include an assembly 404 containing service function binaries 406, 408, and 410. Similarly, application 412 can include an assembly 414 containing service function binaries 416, 418, and 420.

When launched, application 402 can copy the assembly 404 to a memory location accessible by the application, such as an application data space 422. Additionally, application 402 can register with service 426. Service 426 can retrieve the service function binaries 406, 408, and 410 and copy them into AppDomains 428, 432, and 436. Similarly, when application 412 is launched, application 412 can copy the assembly 414 to a memory location accessible by the application, such as an application data space 424. Additionally, application 412 can register with service 426. Service 426 can retrieve the service function binaries 416, 418, and 420 and copy them into AppDomains 430, 434, and 438.

The AppDomains 428 through 438 can be memory locations used by service 426. Since the application may be sandboxed or vitrualized, code stored in application data spaces 422 or 424 may not be executable with sufficient access privileges to perform the service functions, such as interactions with hardware and system level components. Code within AppDomains 428 through 438, as part of service 426, can be executable with sufficient access privileges to hardware and system level components to perform the necessary service functions. In various embodiments, applications 402 and 412 may not have direct access to AppDomains 428 through 438.

To utilize the service functions, application 402 and 412 can make a function call to service 426. Service 426 can provide access to service functions associated with the application. In this way, the necessary service functions can be available to the application. Additionally, even if application 412 utilizes a different version of a service function, both applications can have access to the compatible service function bundled with the application.

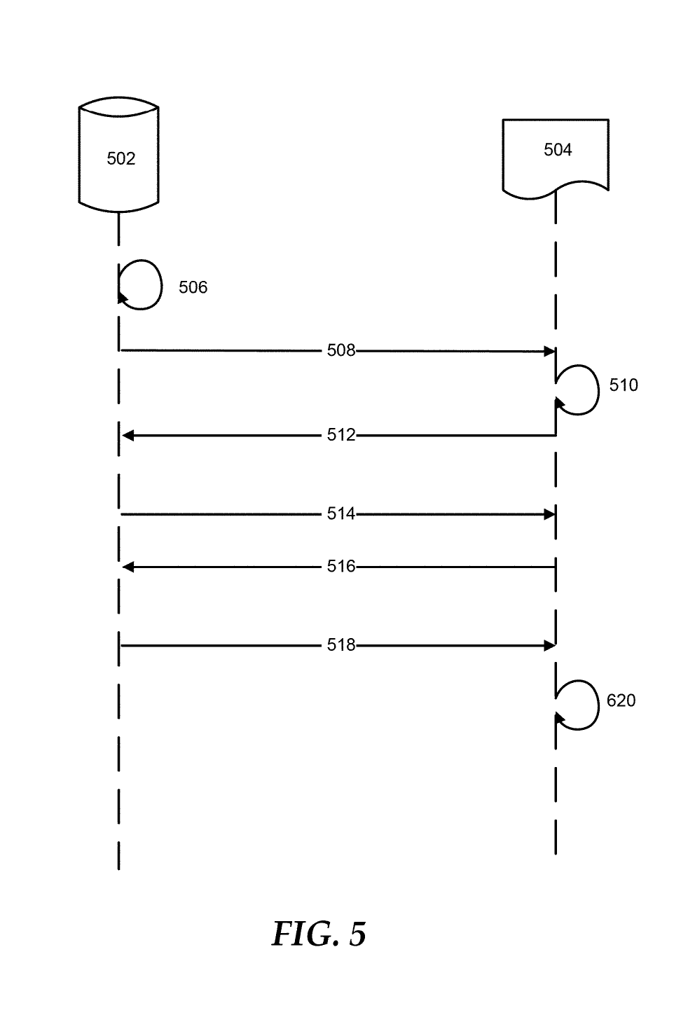

FIG. 5 is a sequence diagram 500 illustrating the interactions between application 502 and service 504. Application 502 can copy the bundled service function binaries to an application data space, as indicated at 506, such as when the application 502 is launched. At 508, the application 502 can register with the service 504. In various embodiments, the service 504 can verify the authenticity of the application 502, such as by checking a trust certificate. Additionally, communication between the application 502 and the service 504 can be secured, such as by using named pipes for inter process communication. At 510, the service 504 can load the service function binaries into AppDomains, and at 512, the service can return a service token to the application 502. The service token can be used to identify which service function binaries are associated with the application 502.

At 514, the application 502 can send a service request to the service 504. In various embodiments, the service token can be used to verify the request is from the application 502 and ensure application 502 has access to the service function binaries provided by application 502 and does not access service function binaries provided by other applications. Service 504 can execute the service function and, at 516, can send a response to the application 502.

In various embodiments, the service function can be dynamically loaded each time the application 502 is executed. When the application finishes, the application 502 can unregister with the service 504, as indicated by 518 and the service can unload the service function binaries at 520.

In other embodiments, the service function binaries can be persistently loaded even after the application is quit. In this way, the service 504 only needs to copy the service function binaries from the application the first time the application is launched. The service functions can be unregistered (518) as part of an application removal or application update process, and the service can unload the service function binaries (520) at that time.

The systems and methods disclosed improve to computer-related technology. Limiting software available to be installed on and executed on an information handling system can significantly reduce the risk of malicious code execution, improving information security and privacy and reducing maintenance and support requirements. However, such limits can negatively impact the functioning of necessary software, such as system configuration tools. Bundling the required functions with the application that can be transferred to a service and executed with higher level access can avoid the requirement for additional user steps to install additional components for the proper operation of the application and ensure reduce the chance of incompatible components crashing the software or otherwise limiting the functionality.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

1. An information handling system comprising:
a hardware processor executing an application including an assembly of at least one service function binary, the application configured to:
send a register request to a service with a location of the assembly; and
send a service call for the service function binary to the service; and
the service configured to:
receive the register request from the application;
copy the assembly to a memory location;
load the service function;
receive the service call from the application; and
perform the requested service function and return the result to the application;
wherein the application is retrieved from an application store and conforms with application store restrictions that prevent the application from directly performing the at least one service function.

2. The information handling system of claim 1, wherein the service function binary includes instructions that when executed perform a service level task required by the application.

3. The information handling system of claim 1, wherein the register request includes a trust certificate or is signed by the trust certificate and the service is further configured to verify the trust certificate prior to copying the assembly to the memory location.

4. The information handling system of claim 1, wherein the service call includes a trust certificate or is signed by the trust certificate and the service is further configured to verify the trust certificate prior to performing the requested service function.

5. The information handling system of claim 1, wherein the service deletes the copy of the assembly from the memory location when the application is closed.

6. The information handling system of claim 1, wherein the service maintains the copy of the assembly in the memory location when the application is closed.

7. The information handling system of claim 5, wherein the service is configured to delete the copy of the assembly from the memory location when the application is deleted or updated.

8. A non-transitory computer-readable medium including an application package comprising:
an assembly including at least one service function having instructions that when executed by a service perform a service level task required by an application; and
the application including instructions that when executed:
register with the service;
provide the assembly location to the service; and
call the service function via the service;
wherein the application package conforms to restrictions of an application store limiting the application from directly performing the service level task.

9. The non-transitory computer-readable medium of claim 8, wherein registering with the service includes utilizes a trust certificate to verify security of the application.

10. The non-transitory computer-readable medium of claim 8, wherein call the at least one service function utilizes a trust certificate to verify security of the application.

11. The non-transitory computer-readable medium of claim 8, wherein the instructions to register with the service include instructions to register each time the application is launched.

12. The non-transitory computer-readable medium of claim 8, wherein the instructions to register with the service include instructions to register the first time the application is launched.

13. A method comprising:
receiving a registration request from an application, the registration request including an assembly location;
copying an assembly from the assembly location to a memory location, the assembly including at least one service function binary, each service function binary including instructions that when executed by the service perform a service level task required by the application;
loading the service function;
receiving a service function call from the application;
executing the at least one service function; and
returning the results of the at least one service function to the application;
wherein the application conforms with application store restrictions preventing he application from directly performing the service level task.

14. The method of claim 13, further comprising verifying a trust certificate of the application prior to copying the assembly to the memory location.

15. The method of claim 13, further comprising verifying a trust certificate of the application prior to prior to performing the requested service function.

16. The method of claim 13, further comprising deleting the copy of the assembly from the memory location when the application is closed.

17. The method of claim 13, further comprising maintaining the copy of the assembly in the memory location when the application is closed.

18. The method of claim 13, further comprising deleting the copy of the assembly from the memory location when the application is deleted or updated.
